(19) United States
(12) Patent Application Publication
(10) Pub. No.: US 2025/0130423 A1
(43) Pub. Date: Apr. 24, 2025

(54) HEAD-UP DISPLAY SYSTEM AND VEHICLE SYSTEM

(71) Applicants: Innolux Corporation, Miaoli County (TW); CARUX TECHNOLOGY PTE. LTD., SINGAPORE (SG)

(72) Inventors: Yu-Chia Huang, Miaoli County (TW); Yu-Jhou Gong, Miaoli County (TW); Tsung-Han Tsai, Miaoli County (TW); Yu-Chien Kao, Tainan (TW)

(73) Assignees: Innolux Corporation, Miaoli County (TW); CARUX TECHNOLOGY PTE. LTD., SINGAPORE (SG)

(21) Appl. No.: 18/830,591

(22) Filed: Sep. 11, 2024

(30) Foreign Application Priority Data
Oct. 19, 2023 (CN) 202311359149.4

(51) Int. Cl. G02B 27/01; B60K 35/231; B60K 35/234; B60K 35/65; G09G 3/00

(52) U.S. Cl. CPC G02B 27/0101; B60K 35/231; B60K 35/234; B60K 35/654; G09G 3/001; B60K 2360/349; G02B 2027/0118; G09G 2320/0233; G09G 2320/0686; G09G 2380/10

(57) ABSTRACT

A head-up display system and a vehicle system are provided. The head-up display system includes a display and a projection screen. The display is configured to display a first image. The projection screen is disposed adjacent to the display and is configured to let the first image to be projected thereon to form a second image. The display includes a first region adjacent to the projection screen and a second region away from the projection screen. The projection screen includes a third region adjacent to the display and a fourth region away from the display. When the display displays the first image, a brightness difference between the first region and the second region is greater than a brightness difference between the third region and the fourth region.

### CROSS-REFERENCE TO RELATED APPLICATION

This application claims the priority benefit of China application serial no. 202311359149.4, filed on Oct. 19, 2023. The entirety of the above-mentioned patent application is hereby incorporated by reference herein and made a part of this specification.

### BACKGROUND

### Technical Field

The disclosure relates to a head-up display system and a vehicle system.

### Description of Related Art

A vehicle projection-type head-up display system may reduce driver's risk of distraction while driving, and has advantages of small size and large-scale projection. However, there are some problems that need to be solved in the current vehicle projection-type head-up display system, such as regional brightness differences or regional chromaticity differences in images, which have a negative impact on a driving experience.

### SUMMARY

The disclosure provides a head-up display system and a vehicle system, which may improve a driving experience.

In some embodiments of the disclosure, the head-up display system includes a display and a projection screen. The display is configured to display a first image. The projection screen is disposed adjacent to the display and is configured to let the first image to be projected thereon to form a second image. The display includes a first region adjacent to the projection screen and a second region away from the projection screen. The projection screen includes a third region adjacent to the display and a fourth region away from the display. When the display displays the first image, a brightness difference between the first region and the second region is greater than a brightness difference between the third region and the fourth region.

In some other embodiments of the disclosure, the vehicle system adjacent to a driver seat includes a display and a windshield. The display is configured to display a first image. The windshield includes a projection screen disposed adjacent to the display and configured to let the first image to be projected thereon to form a second image. The display is disposed between the driver seat and the projection screen and includes a first region adjacent to the driver seat and a second region away from the driver seat. The projection screen includes a third region adjacent to the driver seat and a fourth region away from the driver seat. When the display displays the first image, a brightness difference between the first region and the second region is greater than a brightness difference between the third region and the fourth region.

In some other embodiments of the disclosure, the vehicle system adjacent to a driver seat includes a display and a windshield. The display is configured to display a first image. The windshield includes a projection screen disposed adjacent to the display and configured to let the first image to be projected thereon to form a second image. The display is disposed between the driver seat and the projection screen and includes a first region adjacent to the driver seat and a second region away from the driver seat. The projection screen includes a third region adjacent to the driver seat and a fourth region away from the driver seat. When the display displays the first image, a chromaticity difference between the first region and the second region is greater than a chromaticity difference between the third region and the fourth region.

In order for the aforementioned features and advantages of the disclosure to be more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a head-up display system according to some embodiments of the disclosure.

FIG. 2 is a side view of a head-up display system according to some embodiments of the disclosure.

FIG. 3 to FIG. 5 are respectively exploded views of three displays applicable to embodiments of the disclosure.

FIG. 6 to FIG. 9 are schematic partial cross-sectional views of three displays applicable to the embodiments of the disclosure.

FIG. 10 to FIG. 12 are schematic diagrams of three vehicle systems according to some embodiments of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Certain terms are used throughout the specification of the disclosure and the appended claims to refer to specific components. Those skilled in the art should understand that electronic device manufacturers may probably use different names to refer to the same components. This specification is not intended to distinguish between components that have the same function but different names. In the following specification and claims, the terms “including”, “containing”, etc., are open terms, so that they should be interpreted as meaning of “including but not limited to . . . ”.

Directional terminology mentioned in the specification, such as “top”, “bottom”, “front”, “back”, “left”, “right”, etc., is used with reference to the orientation of the figures being described. Therefore, the used directional terminology is only illustrative, and is not intended to be limiting of the disclosure. In the figures, the drawings illustrate general characteristics of methods, structures, and/or materials used in specific embodiments. However, these drawings should not be construed as defining or limiting of a scope or nature covered by these embodiments. For example, for clarity's sake, a relative size, a thickness and a location of each film layer, region and/or structure may be reduced or enlarged.

One structure (or layer, component, or substrate) described in the disclosure is located on/above another structure (or layer, component, or substrate), which may mean that the two structures are adjacent and directly connected, or mean that the two structures are adjacent and not directly connected. Indirect connection means that there is at least one intermediate structure (or intermediate layer, intermediate component, intermediate substrate, or intermediate spacer) between the two structures, where a lower surface of one structure is adjacent to or directly connected to an upper surface of the intermediate structure, and an upper surface of another structure is adjacent to or directly connected to a lower surface of the intermediate structure. The intermediary structure may be composed of a single-layer or multi-layer physical structure or a non-physical structure, which is not limited by the disclosure. In the disclosure, when a structure is disposed “on” another structure, it may mean that the structure is “directly” on the other structure, or that the structure is “indirectly” on the other structure, i.e., at least one structure is sandwiched between the structure and the other structure.

The terms “about”, “substantially”, or “approximately” are generally interpreted as being within a range of 10% of a given value or range, or as being within a range of 5%, 3%, 2%, 1%, or 0.5% of the given value or range. The ordinal numbers used in the specification and claims, such as “first”, “second”, etc., are used to modify components, and do not imply and represent the component or these components have any previous ordinal numbers, and do not represent a sequence of one component with another, or a sequence in a manufacturing method. The use of these ordinal numbers is only to make a clear distinction between a component with a certain name and another component with the same name. The same terms may not be used in the claims and the specification, and accordingly, a first component in the specification may be a second component in the claims.

The electrical connection or coupling described in the disclosure may refer to direct connection or indirect connection. In the case of direct connection, terminals of components on the two circuits are directly connected or connected to each other by a conductor line segment, and in the case of indirect connection, there are switches, diodes, capacitors, inductors, other suitable components, or a combination of the above components between the terminals of the components on the two circuits, but the disclosure is not limited thereto.

In the disclosure, thickness, length and width may be measured by using an optical microscope (OM), and the thickness or width may be measured through a cross-sectional image in an electron microscope, but the disclosure is not limited thereto. In addition, any two values or directions used for comparison may have certain errors. Moreover, the term “a given range is from a first value to ae second value”, “the given range falls within a range from the first value to the second value” or “the given range is between the first value and the second value” means that the given range includes the first value, the second value, and other values there between. If a first direction is perpendicular to a second direction, an angle between the first direction and the second direction may be between 80 degrees and 100 degrees; and if the first direction is parallel to the second direction, the angle between the first direction and the second direction may be between 0° and 10°.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the disclosure, the electronic device may include a display device, a backlight device, an antenna device, a sensing device or a splicing device, but the disclosure is not limited thereto. The electronic device may be a bendable or flexible electronic device. The display device may be a non-self-luminous display device or a self-luminous display device. The display device may include, for example, liquid crystal (liquid crystal), light emitting diode, fluorescence, phosphor, quantum dot (QD), other suitable display media, or a combination thereof. The antenna device may include, for example, a frequency selective surface (FSS), a radio frequency filter (RF-Filter), a polarizer, a resonator, or an antenna. The antenna may be a liquid crystal type antenna or a non-liquid crystal type antenna. The sensing device may be a sensing device adapted to sense capacitance, light, heat energy or ultrasonic waves, but the disclosure is not limited thereto. In the disclosure, the electronic device may include electronic components, and the electronic components may include passive components and active components, such as capacitors, resistors, inductors, diodes, transistors, etc. The diodes may include light emitting diodes or photodiodes. The light emitting diodes may include, for example, organic light emitting diodes (OLEDs), mini LEDs, micro LEDs or quantum dot LEDs, but the disclosure is not limited thereto. The splicing device may be, for example, a display splicing device or an antenna splicing device, but the disclosure is not limited thereto. It should be noted that the electronic device may be any combination of the above, but the disclosure is not limited thereto. In addition, a shape of the electronic device may be a rectangular shape, a circular shape, a polygonal shape, a shape with curved edges, or other suitable shapes. The electronic device may have a peripheral system such as a driving system, a control system, and a light source system to support display devices, antenna devices, wearable devices (for example, including augmented reality or virtual reality devices), vehicle-mounted devices (for example, including car windshields), or splicing devices.

It should be noted that, in the following embodiments, the features of several different embodiments may be replaced, reorganized, and mixed to complete other embodiments without departing from the spirit of the disclosure. As long as the features of the various embodiments do not violate the spirit of the disclosure or conflict with each other, they may be mixed and matched arbitrarily.

In an embodiment of the disclosure, the head-up display system may be used in a vehicle, and the head-up display system may be integrated with a system in the vehicle to form a vehicle system, but the disclosure is not limited thereto. There is no restriction on the type of the vehicle. In terms of power, the vehicle may be a gasoline vehicle (such as a gasoline vehicle or a diesel vehicle), a gasoline-electric hybrid vehicle, or an electric vehicle, but the disclosure is not limited thereto. The electric vehicle may have more accommodation space than the gasoline vehicle and the gasoline-electric hybrid vehicle. In terms of appearance or function, the vehicle may be a car, a SUV, a sports car, a truck, a bus, a military vehicle, a racing car, a special vehicle, an engineering vehicle or a camper, but the disclosure is not limited thereto. The head-up display system may be used to project image light carrying display information onto a projection screen. The light is transmitted to the driver's eyes through reflection of the projection screen, allowing the driver to see an enlarged virtual image corresponding to the display information in front of him.

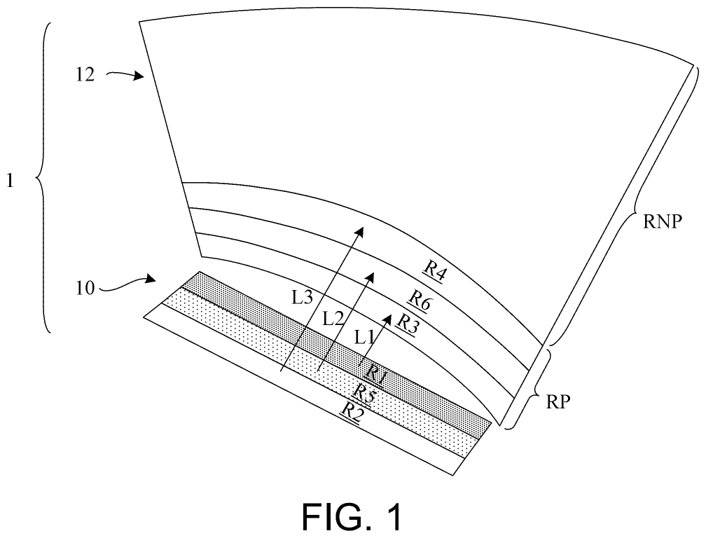

FIG. 1 is a schematic diagram of a head-up display system according to some embodiments of the disclosure. Referring to FIG. 1 first, a head-up display system 1 may include a display 10 and a projection screen 12. The display 10 is configured to display a first image. The projection screen 12 is disposed adjacent to the display 10 and is configured to let the first image to be projected thereon to form a second image. The display 10 includes a first region R1 adjacent to the projection screen 12 and a second region R2 away from the projection screen 12. The projection screen 12 includes a third region R3 adjacent to the display 10 and a fourth region R4 away from the display 10. When the display 10 displays the first image, a brightness difference between the first region R1 and the second region R2 is greater than a brightness difference between the third region R3 and the fourth region R4.

In detail, the display 10 may include a liquid crystal display, a light emitting diode (LED) display, an organic light emitting diode (OLED) display, a fluorescence display, or a phosphor display, a digital light processing (DLP) projector, a liquid crystal on silicon (LCoS) display, a laser scanning system, or any combination of the above, but the disclosure is not limited thereto. The liquid crystal display may include a thin film transistor display, but the disclosure is not limited thereto. The digital light processing projector may include a digital micromirror device (DMD), but the disclosure is not limited thereto. The light emitting diodes may include, for example, organic light emitting diodes (OLEDs), inorganic LEDs, mini LEDs, micro LEDs or quantum dot (QD) LEDs (QLEDs, QDLEDs) or other suitable materials or any combination of the above, but the disclosure is not limited thereto. In addition, a shape of the display 10 may be a rectangle, a circle, a polygon, a shape with curved edges, or other suitable shapes.

The projection screen 12 may be selected from one of the elements of the windshield. For example, although not shown, the windshield may include one or a plurality of elements of a glass structure, a thermal insulation layer, a light-shielding layer dimming structure, an anti-reflective layer, and a baffle, where the glass structure or baffle may be used as the projection screen 12, but the disclosure is not limited thereto.

The glass structure may include single layer glass or multilayer (for example, double layer) glass. If the glass structure includes the multilayer glass, the glass structure may further include an adhesive layer disposed between the multiple layers of glass. A material of the adhesive layer includes, for example, polyvinyl butyral (PVB), but the disclosure is not limited thereto. A thermal insulation layer may be disposed on an outer surface of the glass structure (i.e., a surface of the glass structure facing the outside of the vehicle) and may, for example, fully cover the outer surface to achieve a thermal insulation effect by reducing a transmittance of ambient light. A light shielding layer may be disposed on at least one of the outer surface and an inner surface (i.e., a surface facing the inside of the vehicle) of the glass structure, and may, for example, partially cover the at least one surface to mark image or text, modify appearance, or improve clarity of a projected image by covering the projection region RP of the projection screen 12. A material of the light shielding layer includes, for example, ink, but the disclosure is not limited thereto. A dimming structure may be set on the outer surface or the inner surface of the glass structure, or between the multiple layers of glass of the glass structure, and the dimming structure may be set corresponding to an entire region or a local region of the glass structure to achieve a light shielding effect or enhance the clarity of the projected image. The dimming structure may include dye liquid crystal, polymer dispersed liquid crystal (PDLC), polymer network liquid crystal (PNLC), cholesterol liquid crystal, an electrochromic structure, a suspended particle color-changing material, electronic ink, a photochromic structure or other suitable components or materials, but the disclosure is not limited thereto. For example, the dimming structure may be arranged corresponding to the projection region RP to change a transparency (for example, to reduce the transparency) of the electrochromic structure through voltage modulation, thereby improving the clarity of the projected image, but the disclosure is not limited thereto. The electrochromic structure may include double-layer glass, a double-layer electrode layer disposed between the double-layer glass, and an electrochromic layer disposed between the double-layer electrode layers, but the disclosure is not limited thereto. The anti-reflective layer may be disposed on at least one of the outer surface and the inner surface of the glass structure and may, for example, fully or partially cover the at least one surface to reduce visual interference caused by reflection. The baffle may be a movable baffle, and when projection is performed, the baffle may be raised between the display 10 and the glass structure and set corresponding to the projection region RP. A curvature of the baffle may be the same as or different from a curvature of the projection region RP.

The projection screen 12 may include a non-projection region RNP and the projection region RP for letting the first image to be projected thereon to form a second image, where the projection region RP is, for example, closer to the display 10 than the non-projection region RNP, and the third region R3 and the fourth region R4 are located in the projection region RP.

In some embodiments, the display 10 and the projection region RP of the projection screen 12 may be respectively divided into two or more regions. As shown in FIG. 1, in addition to the first region R1 and the second region R2, the display 10 may further include a fifth region R5 located between the first region R1 and the second region R2, and in addition to the third region R3 and the fourth region R4, the projection screen 12 may further include a sixth region R6 located between the third region R3 and the fourth region R4, but the disclosure is not limited thereto. In other embodiments, the display 10 and the projection region RP of the projection screen 12 may be respectively divided into more regions or fewer regions.

When the display 10 displays the first image, image light (such as image light L1, image light L2, and image light L3) from the display 10 is projected to the projection region RP, and the second image is formed in the projection region RP. For example, the image light L1 from the first region R1 of the display 10 is projected to the third region R3 of the projection screen 12, the image light L2 from the fifth region R5 of the display 10 is projected to the sixth region R6 of the projection screen 12, and the image light L3 from the second region R2 of the display 10 is projected to the fourth region R4 of the projection screen 12, where a light path of the image light L3 is greater than a light path of the image light L2, and the light path of the image light L2 is greater than a light path of the image light L1.

Since a light intensity of the display 10 decreases as the light path of the image light increases, by making the light intensity of the image light with a longer light path greater (or making the light intensity of the image light with a shorter light path smaller), a regional brightness difference in the projection region RP may be reduced or consistency of regional brightness in the projection region RP may be improved. Taking FIG. 1 as an example, when the display 10 displays the first image, the brightness of the first region R1 may be made less than the brightness of the fifth region R5, and the brightness of the fifth region R5 may be made less than the brightness of the second region R2, so that the brightnesses of the third region R3, the sixth region R6 and the fourth region R4 are relatively consistent (for example, the brightnesses are similar or the same). In other words, when the display 10 displays the first image, a brightness difference between the first region R1 and the second region R2 is greater than a brightness difference between the third region R3 and the fourth region R4, and a brightness difference between the first region R1 and the fifth region R5 is greater than a brightness difference between the third region R3 and the sixth region R6.

A method of measuring the brightnesses of different regions may include measuring the brightnesses of different regions under a pure color frame (such as a white frame, a red frame, a green frame or a blue frame). For example, the display 10 may be made to display a pure color image, and then a spectrum measuring instrument (such as CA-310, DMS, CS-2000, SR-3) is fixed at a center position of two eyes of the driver to photograph the first region R1 of the display 10, the second region R2 of the display 10, the third region R3 of the projection screen 12 and the fourth region R4 of the projection screen 12, so as to obtain four brightness distribution maps corresponding to the above four regions. Then, a single point in each brightness distribution map may be taken for brightness comparison or multiple points in each brightness distribution map may be taken for average brightness comparison. Alternatively, a camera or a charge-coupled device (CCD) may be used to take a photo to analyse chromaticities in the photo, and then compare the chromaticities. Specifically, the brightness distribution map shows a brightness distribution under different plane angles φ and solid angles θ. If the single point brightness comparison is performed, the brightnesses at a position of θ=60° and φ=45° in the four brightness distribution maps corresponding to the first region R1, the second region R2, the third region R3, and the fourth region R4 may be used for brightness comparison. For example, in the four brightness distribution maps corresponding to the first region R1, the second region R2, the third region R3 and the fourth region R4, the brightnesses at the position of θ=60° and φ=45° are respectively I1, I2, I3 and I4, then the brightness difference between the first region R1 and the second region R2 may be obtained by subtracting I2 from I1, and the brightness difference between the third region R3 and the fourth region R4 may be obtained by subtracting I4 from I3. Then, by comparing the above two brightness differences, it is confirmed whether to adopt the design solution of the disclosure.

If the average brightness comparison is performed, the brightnesses at the solid angle θ of equal angular intervals under the fixed plane angle φ may be averaged and then the average brightness comparison is performed. For example, under φ=45°, the brightnesses of three points θ=57°, θ=60° and θ=63° may be averaged and then the average brightness comparison is performed (i.e., for each brightness distribution map, the brightnesses of three points are averaged, and then the average brightness is used to compare the brightness difference in different regions). Alternatively, the brightnesses at the solid angle θ of the equal angular intervals under the plane angle φ of equal angular intervals may be averaged, and then the average brightness comparison is performed. For example, under φ=45°, φ=45° and φ=50°, the brightnesses of nine points θ=57°, θ=60° and θ=63° may be averaged and then the average brightness comparison is performed (i.e., for each brightness distribution map, the brightnesses of nine points are averaged, and then the average brightness is used to compare the brightness difference in different regions). It should be understood that the above description is only for convenience of understanding and is not intended to limit the method of measuring the brightness of different regions.

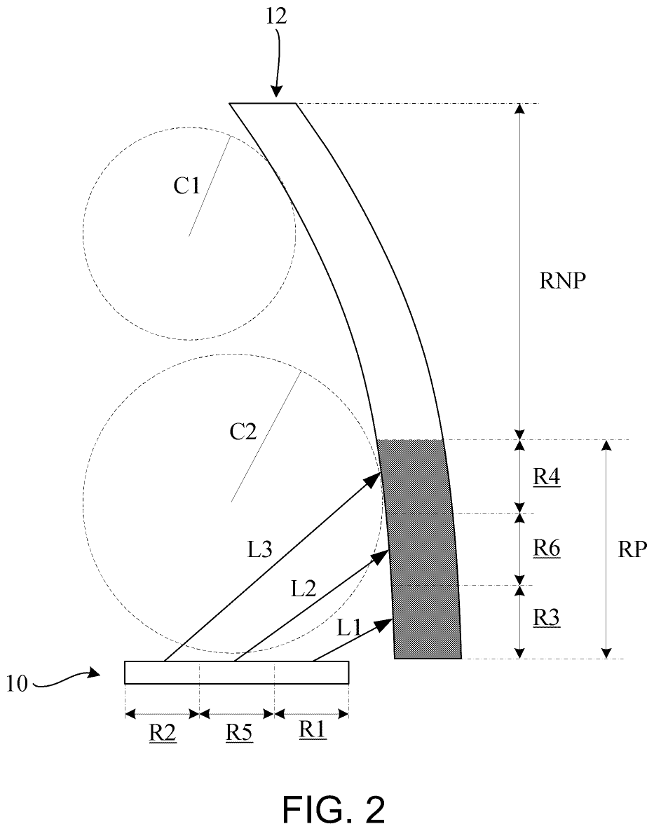

FIG. 2 is a side view of a head-up display system according to some embodiments of the disclosure. Referring to FIG. 2, a surface of the projection screen 12 is, for example, an aspherical curved surface, i.e., the surface of the projection screen 12 may have multiple radii of curvature (FIG. 2 schematically illustrates a radius of curvature C1 and a radius of curvature C2). In some embodiments, a region with smaller curvature in the projection screen 12 may be selected as the projection region RP to reduce an image distortion rate. Since the greater the radius of curvature is, the smaller the curvature is, in FIG. 2, the radius of curvature C2 may be selected as the projection region RP, and the curvature of the projection region RP is less than the curvature of the non-projection region RNP.

In some embodiments, a clarity of the projected image may be improved by reducing a transparency of the projection region RP. As shown in FIG. 2, the transparency of the projection region RP may be less than a transparency of the non-projection region RNP. In some embodiments, the transparency of the projection region RP may be reduced by arranging a light shielding layer, an electrochromic structure or a baffle in the projection region RP, but the disclosure is not limited thereto.

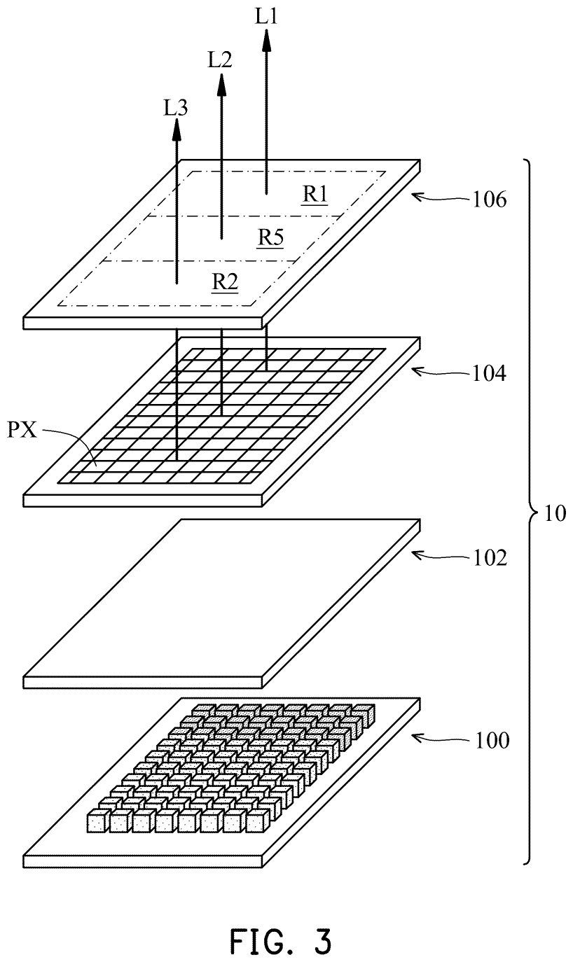

FIG. 3 to FIG. 5 are respectively exploded views of three displays applicable to embodiments of the disclosure. In some embodiments, as shown in FIG. 3, the display 10 may include a light source 100, a first light modulator 102, a display panel 104, and a second light modulator 106, but the disclosure is not limited thereto. The display 10 may add or remove one or more components as needed.

The light source 100 may be used to provide illumination light, and the type of the light source 100 is not limited. For example, the light source 100 may include a direct-under type light source or a side type light source, but the disclosure is not limited thereto. In some embodiments, although not shown in the figure, the light source 100 may include a circuit board, light emitting elements and a heat sink, but the disclosure is not limited thereto. The light source 100 may add or remove one or more components as needed. The light-emitting element may include light-emitting diode (LEDs). The light-emitting diodes may include, for example, a mini LEDs or micro LEDs, but the disclosure is not limited thereto.

The first light modulator 102 is disposed on a transmission path of the illumination light from the light source 100 and is located between the light source 100 and the display panel 104, thereby modulating optical parameters (such as uniformity, collimation, etc.) of the illumination light. The illumination light passes through the first light modulator 102 to form relay modulated light, and the relay modulated light may have better uniformity or collimation than the illumination light, but the disclosure is not limited thereto. For example, the first light modulator may include one or a plurality of relay optical elements, such as one or a plurality of collimators, one or a plurality of lenses, one or a plurality of prisms, one or a plurality of diffusers and/or one or a plurality of light condensing elements, but the disclosure is not limited thereto. In this specification, the first light modulator 102 generally refers to an optical element that substantially maintains a transmission direction of light.

The display panel 104 is disposed on a transmission path of the relay modulated light from the first light modulator 102 and is located between the first light modulator 102 and the second light modulator 106. The display panel 104 may be used to convert the relay modulated light into image light (including image light L1, image light L2 and image light L3) carrying display information (including colors and/or grayscales). For example, the display panel 104 may include a non-self-luminous display panel, such as a liquid crystal display panel, but the disclosure is not limited thereto. The liquid crystal display panel may include a plurality of pixels P arranged in an array to display images. In some embodiments, although not shown, the display panel 104 may include a lower polarizer, a working panel and an upper polarizer arranged in sequence from the first light modulator 102 to the second light modulator 104, where the working panel may include, for example, an array substrate (such as a TFT substrate), a liquid crystal layer, and a color filter (CF) substrate. Alternatively, the working panel may include, for example, a color filter on array (COA) substrate and a liquid crystal layer, but the disclosure is not limited thereto. The display panel 104 may add or remove one or more components as needed.

The second light modulator 106 is disposed on a transmission path of the image light from the display panel 104 and may be used to modulate optical parameters (such as uniformity, collimation, etc.) of the image light. For example, the second light modulator 106 may include one or a plurality of relay optical elements, such as one or a plurality of collimators, one or a plurality of lenses, one or a plurality of prisms, and/or one or a plurality of beam splitters, but the disclosure is not limited thereto. In some embodiments, the second light modulator 106 may also be a cover used for protecting the display panel 104. In some embodiments, the second light modulator 106 may be selectively omitted, but the disclosure is not limited thereto.

In some embodiments, as shown in FIG. 3, regional brightness control may be performed on a plurality of light-emitting elements in the light source 100, for example, the brightness of the plurality of light-emitting elements in the first region R1 is made less than the brightness of the plurality of light-emitting elements in in the fifth region R5, and the brightness of the plurality of light-emitting elements in the fifth region R5 is less than the brightness of the plurality of light-emitting elements in the second region R2, so that the brightness of the image light L1 emitted from the first region R1 of the display 10 is less than the brightness of the image light L2 emitted from the fifth region R5 of the display 10, and the brightness of the image light L2 emitted from the fifth region R5 of the display 10 is less than the brightness of the image light L3 emitted from the second region R2 of the display 10.

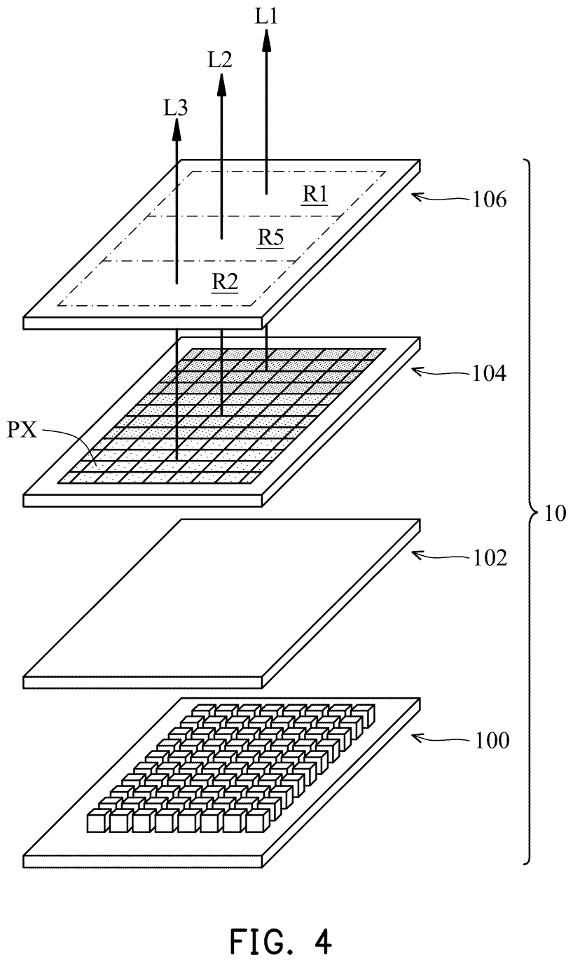

In other embodiments, as shown in FIG. 4, the plurality of light-emitting elements in the light source 100 may have a consistent brightness, and regional transmittance control may be performed on the plurality of pixels P of the display panel 104, for example, the transmittance of the plurality of pixels P in the first region R1 is made less than the transmittance of the plurality of pixels P in the fifth region R5 through electronic control, and the transmittance of the plurality of pixels P in the fifth region R5 is made less than the transmittance of the plurality of pixels P in the second region R2, so that the brightness of the image light L1 emitted from the first region R1 of the display 10 is less than the brightness of the image light L2 emitted from the fifth region R5 of the display 10, and the brightness of the image light L2 emitted from the fifth region R5 of the display 10 is less than the brightness of the image light L3 emitted from the second region R2 of the display 10.

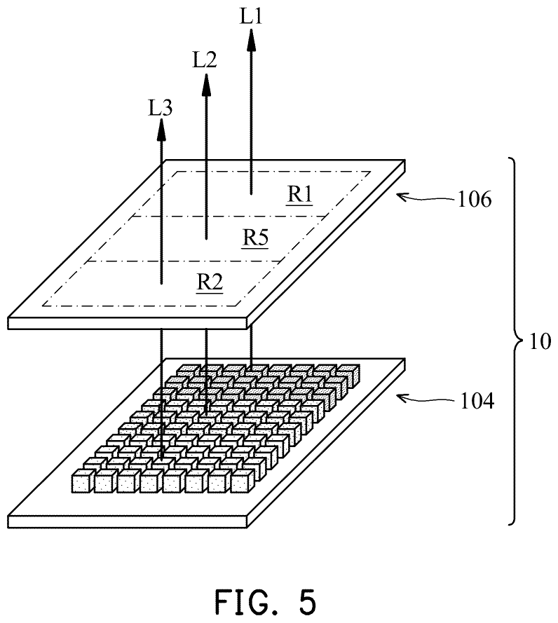

In some embodiments, as shown in FIG. 5, the display 10 may include the display panel 104 and the second light modulator 106 and does not include the aforementioned light source 100 and first light modulator 102, where the display panel 104 may be, for example, a self-luminous display panel includes a plurality of light-emitting elements. Under such framework, regional brightness control may be performed on the plurality of light-emitting elements in the display panel 104, for example, the brightness of the plurality of light-emitting elements in the first region R1 is made less than the brightness of the plurality of light-emitting elements in the fifth region R5, and the brightness of the plurality of light-emitting elements in the fifth region R5 is made less than the brightness of the plurality of light-emitting elements in the second region R2, so that the brightness of the image light L1 emitted from the first region R1 of the display 10 is less than the brightness of the image light L2 emitted from the fifth region R5 of the display 10, and the brightness of the image light L2 emitted from the fifth region R5 of the display 10 is less than the brightness of the image light L3 emitted from the second region R2 of the display 10.

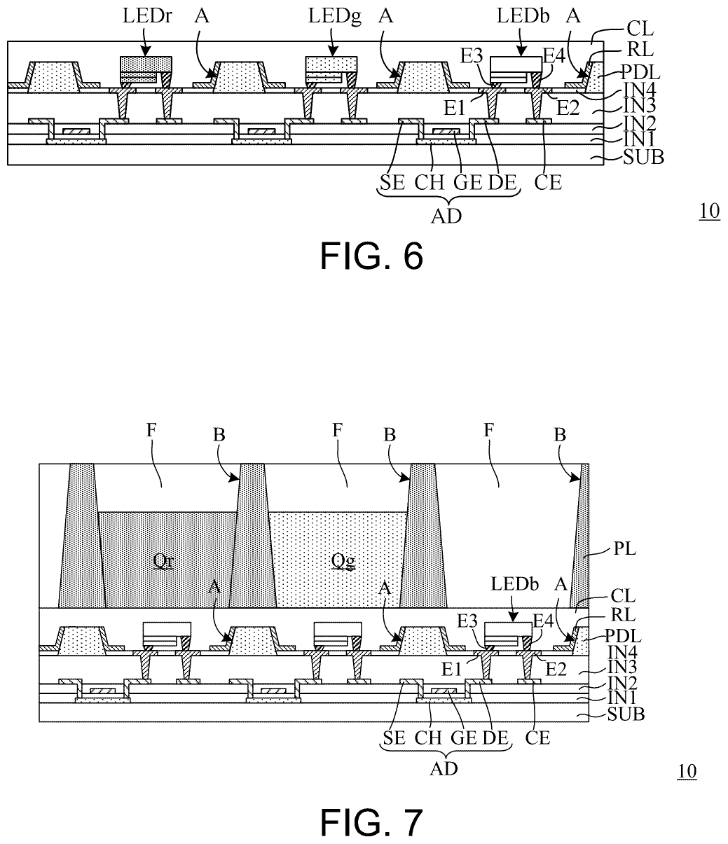

FIG. 6 to FIG. 9 are schematic partial cross-sectional views of three displays applicable to the embodiments of the disclosure. In some embodiments, the plurality of light-emitting elements in the display 10 may include light-emitting elements of different colors. As shown in FIG. 6, the display 10 may include a substrate SUB, a plurality of semiconductor patterns CH, a dielectric layer IN1, a plurality of gate electrodes GE, a dielectric layer IN2, a plurality of source electrodes SE, a plurality of drain electrodes DE, a plurality of common electrodes CE, a dielectric layer IN3, a pixel definition layer PDL, a dielectric layer IN4, a plurality of first electrodes E1, a plurality of second electrodes E2, a reflective layer RL, a plurality of light-emitting elements (such as red light-emitting elements LEDr, green light-emitting elements LEDg and blue light-emitting element LEDb) and an encapsulation layer CL, but the disclosure is not limited thereto.

The substrate SUB may be a rigid substrate or a flexible substrate. A material of the substrate SUB includes, for example, glass, quartz, ceramics, sapphire or plastics, but the disclosure is not limited thereto. The plastics may include polycarbonate (PC), polyimide (PI), polypropylene (PP), polyethylene terephthalate (PET), polyethylene naphthalate (PEN), polyether sulphone (PES), poly (methyl methacrylate) (PMMA) and other suitable flexible materials or combinations of the aforementioned materials, but the disclosure is not limited thereto. In some embodiments, a thickness of the substrate SUB may be less than 1000 μm. For example, the thickness of the substrate SUB may be between 5 μm and 30 μm (5 μm≤thickness≤30 μm), but the disclosure is not limited thereto. In addition, a light transmittance of the substrate SUB is not limited, namely, the substrate SUB may be a transparent substrate, a semi-transparent substrate or an opaque substrate.

The plurality of semiconductor patterns CH are provided on the substrate SUB. A material of the plurality of semiconductor patterns CH include, for example, silicon semiconductor, oxide semiconductor or other suitable semiconductor materials. The silicon semiconductor includes, for example, amorphous silicon or polycrystalline silicon. The oxide semiconductor includes, for example, indium tin oxide (ITO), indium zinc oxide (IZO), indium gallium oxide (IGO), or indium gallium zinc oxide (IGZO), but the disclosure is not limited thereto.

The dielectric layer IN1 is provided on the plurality of semiconductor patterns CH and the substrate SUB. A material of the dielectric layer IN1 includes, for example, an organic insulating material, an inorganic insulating material or a combination thereof. The organic insulating material includes, for example, polymethylmethacrylate (PMMA), epoxy, acrylic-based resin, silicone, polyimide polymer, or combinations thereof, but the disclosure is not limited thereto. The inorganic insulating material includes, for example, silicon oxide or silicon nitride, but the disclosure is not limited thereto.

The plurality of gate electrodes GE are disposed on the dielectric layer IN1 and are respectively located above the plurality of semiconductor patterns CH. A material of the plurality of gate electrodes GE includes, for example, metal or a metal stacked layer, such as aluminum, molybdenum or titanium/aluminum/titanium, but the disclosure is not limited thereto.

The dielectric layer IN2 is disposed on the plurality of gate electrodes GE and the dielectric layer IN1. A material of the dielectric layer IN2 may refer to the materials listed for the dielectric layer IN1, which will not be repeated here.

The plurality of source electrodes SE, the plurality of drain electrodes DE and the plurality of common electrodes CE are disposed on the dielectric layer IN2, where each source electrode SE penetrates through the dielectric layer IN2 and is electrically connected to a source region (not indicated) of one corresponding semiconductor pattern CH, and each drain electrode DE penetrates through the dielectric layer IN2 and is electrically connected to a drain region (not indicated) of one corresponding semiconductor pattern CH. In some embodiments, the display 10 may include a plurality of active devices AD, and each active device AD includes, for example, a gate electrode GE, a semiconductor pattern CH, a source electrode SE, and a drain electrode DE, but the disclosure is not limited thereto.

The dielectric layer IN3 is disposed on the plurality of source electrodes SE, the plurality of drain electrodes DE, the plurality of common electrodes CE and the dielectric layer IN2. A material of the dielectric layer IN3 may refer to the materials listed for the dielectric layer IN1, which will not be repeated here.

The pixel definition layer PDL is disposed on the dielectric layer IN3 and has a plurality of openings A for accommodating the plurality of light-emitting elements. A material of the pixel definition layer PDL includes, for example, an opaque organic polymer material to reduce problems such as interference and/or light mixing between adjacent light-emitting elements. The opaque organic polymer material may be a white, gray or black organic polymer material, such as a black matrix, but the disclosure is not limited thereto. In some embodiments, a material of the pixel definition layer PDL may include a transparent organic polymer material. The transparent organic polymer material may include resin, but the disclosure is not limited thereto.

The dielectric layer IN4 is disposed on the dielectric layer IN3 and is located in the plurality of openings A. A material of the dielectric layer IN4 may refer to the materials listed for the dielectric layer IN1, which will not be repeated here.

The plurality of first electrodes E1 and the plurality of second electrodes E2 are disposed on the dielectric layer IN3 and located in the plurality of openings A, and the dielectric layer IN4 exposes the plurality of first electrodes E1 and the plurality of second electrodes E2. Each first electrode E1 penetrates through the dielectric layer IN3 and is electrically connected to one corresponding drain electrode DE, and each second electrode E2 penetrates through the dielectric layer IN3 and is electrically connected to one corresponding common electrode CE. A material of the plurality of first electrodes E1 and the plurality of second electrodes E2 includes, for example, metal or a metal stacked layer, such as aluminum, molybdenum or titanium/aluminum/titanium, but the disclosure is not limited thereto.

The reflective layer RL is disposed on a side wall of the pixel definition layer PDL and covers at least a part of the dielectric layer IN4. A material of the reflective layer RL includes, for example, metal, alloy, or a combination thereof. By arranging the reflective layer RL on the side wall of the pixel definition layer PDL, the large-angle light beam from the light-emitting elements may be reflected, thereby improving light utilization rate or reducing light mixing.

The plurality of light-emitting elements may include, for example, a plurality of red light-emitting elements LEDr (only one is shown schematically), a plurality of green light-emitting elements LEDg (only one is shown schematically), and a plurality of blue light-emitting elements LEDb (only one is shown schematically). Each light-emitting element may include an electrode E3 and an electrode E4, where the electrode E3 may be electrically connected to the drain electrode DE of one corresponding active device AD through the first electrode E1, and the electrode E4 may be electrically connected to one corresponding common electrode CE through the second electrode E2.

The encapsulation layer CL is disposed on the pixel definition layer PDL, the reflective layer RL, the dielectric layer IN4, the plurality of first electrodes E1, the plurality of second electrodes E2, and the plurality of light-emitting elements. A material of the encapsulation layer CL includes, for example, silicon oxide, silicon nitride, or an acrylic-based polymer material, but the disclosure is not limited thereto.

In some embodiments, the plurality of light-emitting elements in the display 10 may all be light-emitting elements of the same color, and the display 10 may further include a color conversion pattern. As shown in FIG. 7, the plurality of light-emitting elements in the display 10 may all be blue light-emitting elements LEDb (or ultraviolet light-emitting elements). In addition, the display 10 may further include a spacer layer PL, a plurality of color conversion patterns (such as a color conversion pattern Qr and a color conversion pattern Qg), and a filling layer F. The spacer layer PL is provided on the encapsulation layer CL and has a plurality of openings B. The plurality of openings B respectively overlap with the plurality of blue light-emitting elements LEDb. A material of the spacer layer PL includes, for example, the aforementioned organic materials, but the disclosure is not limited thereto. The plurality of color conversion patterns are respectively filled in the plurality of openings B of the spacer layer PL, and a number of the plurality of openings is greater than a number of the plurality of color conversion patterns. Namely, a part of the openings are not filled with the color conversion patterns. A material of the plurality of color conversion patterns includes, for example, fluorescence, phosphor, quantum dots (QDs), other suitable materials, or combinations thereof, but the disclosure is not limited thereto. In some embodiments, the material of the plurality of color conversion patterns may be made of chromium (Cd)-free materials in order to be environmentally friendly. For example, the material of the plurality of color conversion patterns may include zinc selenide (ZnSe), graphene quantum dots (GQD), silicon quantum dots (SiQD), indium phosphide (InP), copper indium selenide (CulnSe) or indium arsenide (InAs), but the disclosure is not limited thereto. The filling layer F fills the openings B where the color conversion patterns are not provided and the openings B where the color conversion patterns are provided. A material of the filling layer F includes, for example, optical clear adhesive (OCA) or optical clear resin (OCR), but the disclosure is not limited thereto.

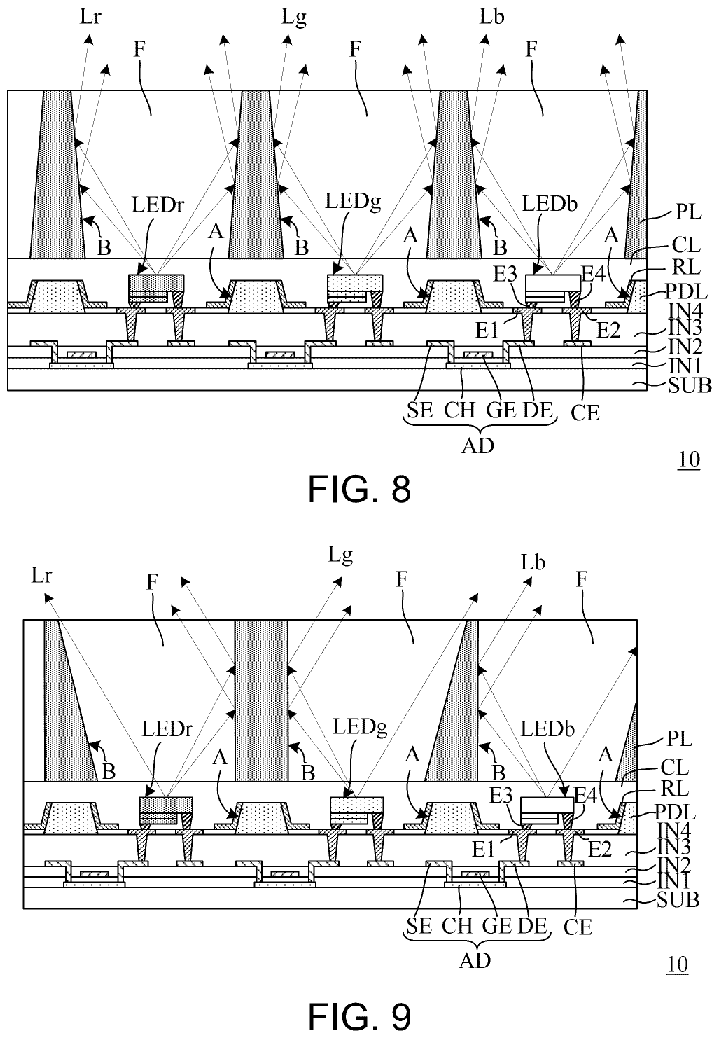

In some embodiments, the display 10 may use the design of the spacer layer PL to improve light collimation and/or meet special display requirements. As shown in FIG. 8 and FIG. 9, under the structure of multi-color light-emitting elements, the display 10 may further include the spacer layer PL and the filling layer F. By changing an angle of the side wall of the spacer layer PL, the light path may be changed so that light of different colors (such as red light Lr, green light Lg and blue light Lb) is transmitted in a specified direction.

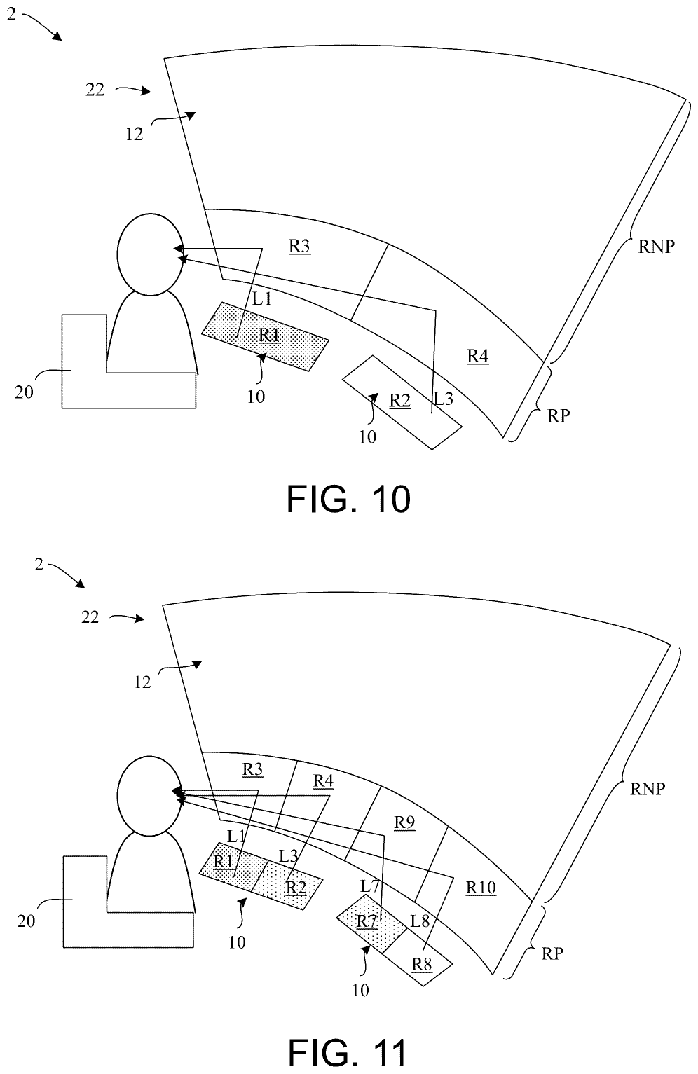

FIG. 10 to FIG. 12 are schematic diagrams of three vehicle systems according to some embodiments of the disclosure. Referring to FIG. 10, a vehicle system 2 adjacent to a driver seat 20 may include a display 10 and a windshield 22. The display 10 is configured to display a first image. The windshield 22 includes a projection screen 12 disposed adjacent to the display 10 for letting the first image to be projected thereon to form a second image. The display 10 is disposed between the driver seat 20 and the projection screen 12 and includes a first region R1 adjacent to the driver 20 and a second region R2 away from the driver seat 20. The projection screen 12 includes a third region R3 adjacent to the driver seat 20 and a fourth region R4 away from the driver seat 20. When the display 10 displays the first image, a brightness difference between the first region R1 and the second region R2 is greater than a brightness difference between the third region R3 and the fourth region R4.

As mentioned above, the light intensity of the display 10 decreases as the light path of the image light increases. In addition, a reflectivity of a multi-layer film structure of the windshield 22 (for example, including a glass structure, a heat insulation layer, etc.) for large-angle incident light is lower than a reflectivity for small-angle incident light. Therefore, by making the light intensity of the image light from the region farther away from the driver in the display 10 larger (or making the light intensity of the image light from the region closer to the driver in the display 10 smaller), the regional brightness differences in the projection region RP is reduced or the consistency of regional brightness in the projection region RP is improved. Taking FIG. 10 as an example, when the display 10 displays the first image, the brightness of the first region R1 may be made less than the brightness of the second region R2, so that the brightnesses of the third region R3 and the fourth region R4 are more consistent (for example, the brightnesses are similar or the same). In other words, when the display 10 displays the first image, the brightness difference between the first region R1 and the second region R2 is greater than the brightness difference between the third region R3 and the fourth region R4.

The method of measuring the brightness of different region in the embodiment may be deduced with reference of the aforementioned embodiment, and detail thereof is not repeated here. Regarding the curvature design or transparency design of the projection screen 12, reference may also be made to the description in FIG. 2 and details thereof are not repeated here. The display 10 may adopt the design described in any one of FIG. 3 to FIG. 9, which will not be repeated here.

In FIG. 10, the first region R1 and the second region R2 of the display 10 are separated from each other. For example, the first region R1 and the second region R2 may be two independent display panels, but the disclosure is not limited thereto. In other embodiments, the first region R1 and the second region R2 may be connected to each other, and the first region R1 and the second region R2 may be two different regions of a single display panel. As shown in FIG. 11, the single display panel may be divided into a plurality of regions, and the light intensity of the image light from the region farther away from the driver in the display 10 is increased (or the light intensity of the image light from the region closer to the driver in the display 10 is decreased), so as to reduce the regional brightness difference in the projection region RP or improve the regional brightness consistency in the projection region RP. Taking FIG. 11 as an example, in the display 10, the first region R1, the second region R2, a seventh region R7, and an eighth region R8 are arranged in a direction away from the driver. Therefore, the light intensity of the image light L1 from the first region R1 may be made less than the light intensity of the image light L3 from the second region R2, the light intensity of the image light L3 from the second region R2 may be made less than the light intensity of the image light L7 from the seventh region R7, and the light intensity of the image light L7 from the seventh region R7 is made less than the light intensity of the image light L8 from the eighth region R8, so as to enhance the brightness consistency of the third region R3, the fourth region R4, the ninth region R9 and the tenth region R10 in the projection region RP.

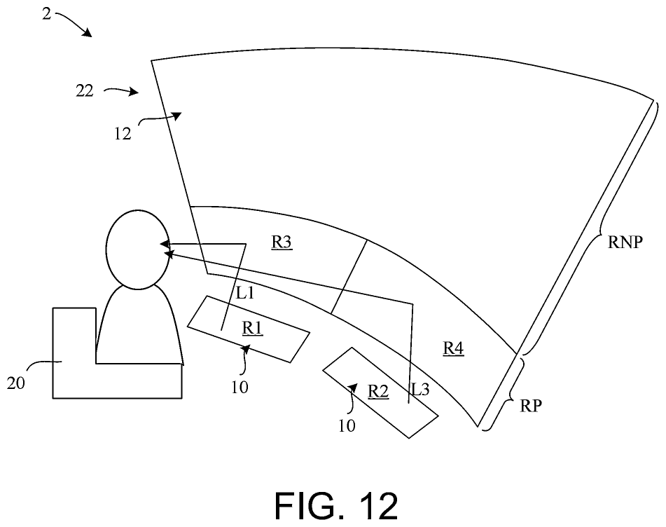

Referring to FIG. 12, the vehicle system 2 adjacent to the driver seat 20 may include the display 10 and the windshield 22. The display 10 is configured to display the first image. The windshield 22 includes the projection screen 12 disposed adjacent to the display 10 for letting the first image to be projected thereon to form the second image. The display 10 is disposed between the driver seat 20 and the projection screen 12 and includes the first region R1 adjacent to the driver seat 20 and the second region R2 away from the driver seat 20. The projection screen 12 includes the third region R3 adjacent to the driver seat 20 and the fourth region R4 away from the driver seat 20. When the display 10 displays the first image, a brightness difference between the first region R1 and the second region R2 is greater than a brightness difference between the third region R3 and the fourth region R4.

In detail, a reflection spectrum of the multi-layer film structure of the windshield 22 (for example, including a glass structure, a heat insulation layer, etc.) may shift toward shorter wavelengths as the angle increases. In other words, the larger the reflection angle is, the more bluish the image will be. By performing chromaticity compensation on different display regions, the chromaticity consistency between different regions in the projection region RP may be improved, and driver's driving risk caused by misjudgement of colors may be reduced. For example, when the display 10 displays the first image, the chromaticity of the second region R2 may be made redder than the chromaticity of the first region R1. Taking the CIE1931 color space as an example, if color coordinates of the first region R1 are (x1, y1) and color coordinates of the second region R2 are (x2, y2), x1<x2, and y1<y2 may be made to implement chromaticity compensation. In some embodiments, the chromaticity consistency between different regions may generally refer to a color coordinate difference between the third region R3 and the fourth region R4 under a red screen being less than 0.01, such as |x2−x1|<0.01 and/or |y2−y1|<0.01. In some embodiments, the chromaticity consistency between different regions may generally refer to the color coordinate difference between the third region R3 and the fourth region R4 under a white screen being less than 0.01, such as |x2−x1|<0.01 and/or |y2−y1|<0.01.

The method of measuring the chromaticity of different regions may include measuring the chromaticity of different regions under a pure color frame (such as a white frame, a red frame, a green frame or a blue frame). For example, the display 10 may be made to display a pure color image (for example, a white frame or a red frame), and then a spectrum measuring instrument (such as CA-310, DMS, CS-2000, SR-3) is fixed at a center position of two eyes of the driver to photograph the first region R1 of the display 10, the second region R2 of the display 10, the third region R3 of the projection screen 12 and the fourth region R4 of the projection screen 12, so as to obtain four spectrums corresponding to the above four regions. Then, the four spectrums are converted into color coordinates for chromaticity comparison. Alternatively, the reflection spectrum of the windshield 22 and a spectrum of the display 10 may also be measured, and then the reflection spectrum of the windshield 22 and the spectrum of the display 10 are multiplied and then converted into the color coordinates for chromaticity comparison. Alternatively, a camera or a charge-coupled device (CCD) may be used to take a photo, and the chromaticity in the photo is analysed to perform chromaticity comparison.

In summary, in the embodiments of the disclosure, preliminary brightness or chromaticity compensation may be performed on different regions of the display to improve the brightness or chromaticity consistency of the image formed on the projection screen, thereby improving the driving experience.

The above embodiments are only used to illustrate the technical solution of the disclosure, but not to limit it; although the disclosure has been described in detail with reference to the foregoing embodiments, those with ordinary knowledge in the technical field should understand that: the technical solutions described in the foregoing embodiments may still be modified, or some or all of the technical features may be equivalently replaced; and these modifications or replacements do not cause the essence of the corresponding technical solutions to depart from the scope of the technical solutions of the embodiments of the disclosure.

Although the embodiments of the disclosure and their advantages have been disclosed above, it should be understood that anyone with ordinary knowledge in the art may make changes, substitutions and modifications without departing from the spirit and scope of the disclosure, and the features of each embodiment may be arbitrarily mixed and replaced with each other to form other new embodiments. In addition, the protection scope of the disclosure is not limited to the processes, machines, manufacturing, material compositions, devices, methods and steps in the specific embodiments described in the specification, anyone with ordinary skill in the art may understand processes, machines, manufacturing, material compositions, devices, methods and steps currently or developed in the future from the disclosed content of the disclosure, so long as they may implement substantially the same functions or obtain substantially the same results in the embodiments described herein. Therefore, the protection scope of the disclosure includes the above-mentioned processes, machines, manufacturing, material compositions, devices, methods and steps. In addition, each claim constitutes an individual embodiment, and the protection scope of the disclosure also includes combinations of each claim and embodiment. The protection scope of the disclosure shall be determined by the scope of the accompanying patent applications.

What is claimed is:

1. A head-up display system, comprising:
a display configured to display a first image; and
a projection screen disposed adjacent to the display and configured to let the first image to be projected thereon to form a second image, wherein
the display comprises a first region adjacent to the projection screen and a second region away from the projection screen,
the projection screen comprises a third region adjacent to the display and a fourth region away from the display, and
when the display displays the first image, a brightness difference between the first region and the second region is greater than a brightness difference between the third region and the fourth region.

2. The head-up display system according to claim 1, wherein when the display displays the first image, a brightness of the first region is less than a brightness of the second region.

3. The head-up display system according to claim 1, wherein the projection screen comprises a non-projection region and a projection region configured to let the first image to be projected thereon to form the second image, and the third region and the fourth region are located in the projection region, wherein:
a curvature of the projection region is less than a curvature of the non-projection region.

4. The head-up display system according to claim 1, wherein the projection screen comprises a non-projection region and a projection region configured to let the first image to be projected thereon to form the second image, and the third region and the fourth region are located in the projection region, wherein
a transparency of the projection region is less than a transparency of the non-projection region.

5. The head-up display system according to claim 4, wherein the projection screen further comprises a dimming structure disposed corresponding to the projection region.

6. The head-up display system according to claim 5, wherein the dimming structure comprises dye liquid crystal, polymer dispersed liquid crystal (PDLC), polymer network liquid crystal (PNLC), cholesterol liquid crystal, an electrochromic structure, a suspended particle color-changing material, electronic ink, or a photochromic structure.

7. The head-up display system according to claim 4, wherein the projection screen further comprises a light shielding layer or a baffle disposed corresponding to the projection region.

8. A vehicle system, adjacent to a driver seat, and comprising:
a display configured to display a first image; and
a windshield comprising a projection screen disposed adjacent to the display and configured to let the first image to be projected thereon to form a second image, wherein
the display is disposed between the driver seat and the projection screen and comprises a first region adjacent to the driver seat and a second region away from the driver seat,
the projection screen comprises a third region adjacent to the driver seat and a fourth region away from the driver seat, and
when the display displays the first image, a brightness difference between the first region and the second region is greater than a brightness difference between the third region and the fourth region.

9. The vehicle system according to claim 8, wherein when the display displays the first image, a brightness of the first region is less than a brightness of the second region.

10. The vehicle system according to claim 8, wherein the projection screen comprises a non-projection region and a projection region configured to let the first image to be projected thereon to form the second image, and the third region and the fourth region are located in the projection region, wherein
a curvature of the projection region is less than a curvature of the non-projection region.

11. The vehicle system according to claim 8, wherein the projection screen comprises a non-projection region and a projection region configured to let the first image to be projected thereon to form the second image, and the third region and the fourth region are located in the projection region, wherein
a transparency of the projection region is less than a transparency of the non-projection region.

12. The vehicle system according to claim 11, wherein the projection screen further comprises a dimming structure disposed corresponding to the projection region.

13. The vehicle system according to claim 12, wherein the dimming structure comprises dye liquid crystal, polymer dispersed liquid crystal (PDLC), polymer network liquid crystal (PNLC), cholesterol liquid crystal, an electrochromic structure, a suspended particle color-changing material, electronic ink, or a photochromic structure.

14. The vehicle system according to claim 11, wherein the projection screen further comprises a light shielding layer or a baffle disposed corresponding to the projection region.

15. A vehicle system, adjacent to a driver seat, and comprising:
a display configured to display a first image; and
a windshield comprising a projection screen disposed adjacent to the display and configured to let the first image to be projected thereon to form a second image, wherein
the display is disposed between the driver seat and the projection screen and comprises a first region adjacent to the driver seat and a second region away from the driver seat,
the projection screen comprises a third region adjacent to the driver seat and a fourth region away from the driver seat, and
when the display displays the first image, a chromaticity difference between the first region and the second region is greater than a chromaticity difference between the third region and the fourth region.

16. The vehicle system according to claim 15, wherein when the display displays the first image, a chromaticity of the second region is redder than a chromaticity of the first region.

17. The vehicle system according to claim 15, wherein color coordinates of the first region are (x1, y1), and color coordinates of the second region are (x2, y2), wherein x1<x2, and y1<y2.

18. The vehicle system according to claim 15, wherein the projection screen comprises a non-projection region and a projection region configured to let the first image to be projected thereon to form the second image, and the third region and the fourth region are located in the projection region, wherein
a curvature of the projection region is less than a curvature of the non-projection region.

19. The vehicle system according to claim 15, wherein the projection screen comprises a non-projection region and a projection region configured to let the first image to be projected thereon to form the second image, and the third region and the fourth region are located in the projection region, wherein
a transparency of the projection region is less than a transparency of the non-projection region.

20. The vehicle system according to claim 19, wherein the projection screen further comprises a dimming structure, a light shielding layer, or a baffle disposed corresponding to the projection region.
